(19) United States
(12) Patent Application Publication
(10) Pub. No.: US 2016/0306387 A1
(43) Pub. Date: Oct. 20, 2016

(54) CAR MULTIMEDIA DEVICE

(71) Applicant: HON HAI PRECISION INDUSTRY CO., LTD., New Taipei (TW)

(72) Inventors: FANG-CHEN WU, New Taipei (TW); HUI-YU CHAN, New Taipei (TW); KENG-CHIH LIN, New Taipei (TW); JYUN-MENG YANG, New Taipei (TW); WEN-CHI HUANG, New Taipei (TW)

(21) Appl. No.: 14/716,118

(22) Filed: May 19, 2015

(30) Foreign Application Priority Data
Apr. 16, 2015 (CN) 201510180294.5

(51) Int. Cl. G06F 1/16; G06F 1/26; G06F 13/40

(52) U.S. Cl. CPC G06F 1/1632; G06F 13/4081; G06F 1/266

(57) ABSTRACT

A car multimedia device includes a positioning board, a display and a data transmitting chip. The data transmitting chip is near the positioning board and is coupled to the display. A docking bay is defined in the multimedia device for docking an electronic device. The positioning board is located on one side of the docking bay. When the electronic device is located in the docking bay, the electronic device is configured to lean against the positioning board for facilitating coupling to the data transmitting chip.

### CROSS-REFERENCE TO RELATED APPLICATIONS

This application claims priority to Chinese Patent Application No. 201510180294.5 filed on Apr. 16, 2015, the contents of which are incorporated by reference herein.

### FIELD

The subject matter herein generally relates to a car multimedia device.

### BACKGROUND

A traditional car multimedia device is limited and uses video head units and bulky media player such as VCR or DVD systems and must use local media files.

### BRIEF DESCRIPTION OF THE DRAWINGS

Implementations of the present technology will now be described, by way of example only, with reference to the attached figures.

FIG. 1 is a diagrammatic view of a car multimedia device and an electronic device in one embodiment.

FIG. 2 is a diagrammatic view of an embodiment of the car multimedia device of FIG. 1 in one embodiment.

FIG. 3 is an isometric view of an embodiment of the electronic device of FIG. 1 in one embodiment.

FIG. 4 is similar to FIG. 2, but the electronic device is installed in the car multimedia device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to zoom and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

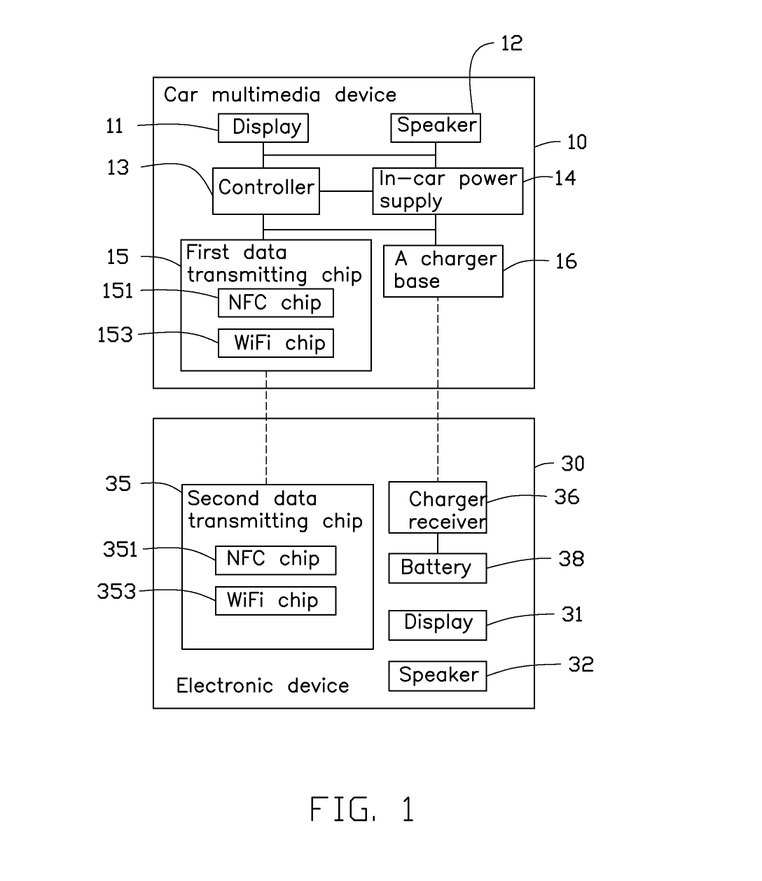

FIG. 1 illustrates a block diagram of a car multimedia device 10 and an electronic device 30. The car multimedia device 10 includes a display 11, a speaker 12, a controller 13, an in-car power supply 14, a first data transmitting chip 15, and a charger base 16. The car multimedia device 10 can be installed in a vehicle for playing multimedia content. The display 11, the speaker 12, the controller 13, the first data transmitting chip 15, and the charger base 16 are coupled to the in-car power supply 14. The display 11, the speaker 12, the first data transmitting chip 15, and the charger base 16 are coupled to the controller 13. The first data transmitting chip 15 can include a near field communication (NFC) chip 151 and a WiFi chip 153.

The electronic device 30 can be a tablet computer or a smart phone. The electronic device 30 includes a display 31, a speaker 32, a second data transmitting chip 35, a charger receiver 36, and a battery 38. The first data transmitting chip 15 can couple to the second data transmitting chip 35. The second data transmitting chip 35 can include a NFC chip 351 and a WiFi chip 353. The battery 38 is connected to the charger receiver 36 and can be wirelessly charged through the charger base 16.

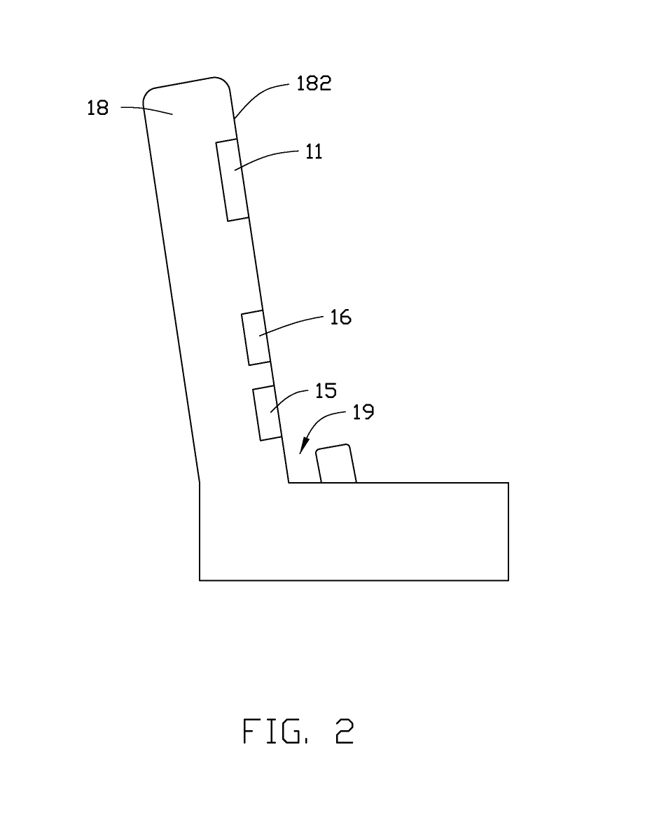

FIG. 2 illustrates the car multimedia device in a schematic view. The car multimedia device 10 includes a dock 18 for positioning the electronic device 30. The dock 18 defines a docking bay 19. The docking bay 19 is substantially U-shaped. The dock 18 includes a positioning board 182. When the dock 18 is in use, the positioning board 182 is slanted relative to a horizontal plane so that the electronic device 30 can lean against the positioning board 182. The display 11, the speaker 12, the first data transmitting chip 15, and the charger base 16 are located in the dock 18. The first data transmitting chip 15, the charger base 16, the display 11 are near to the positioning board 182 and are aligned from down to up along the positioning board 182 and substantially on a same plane.

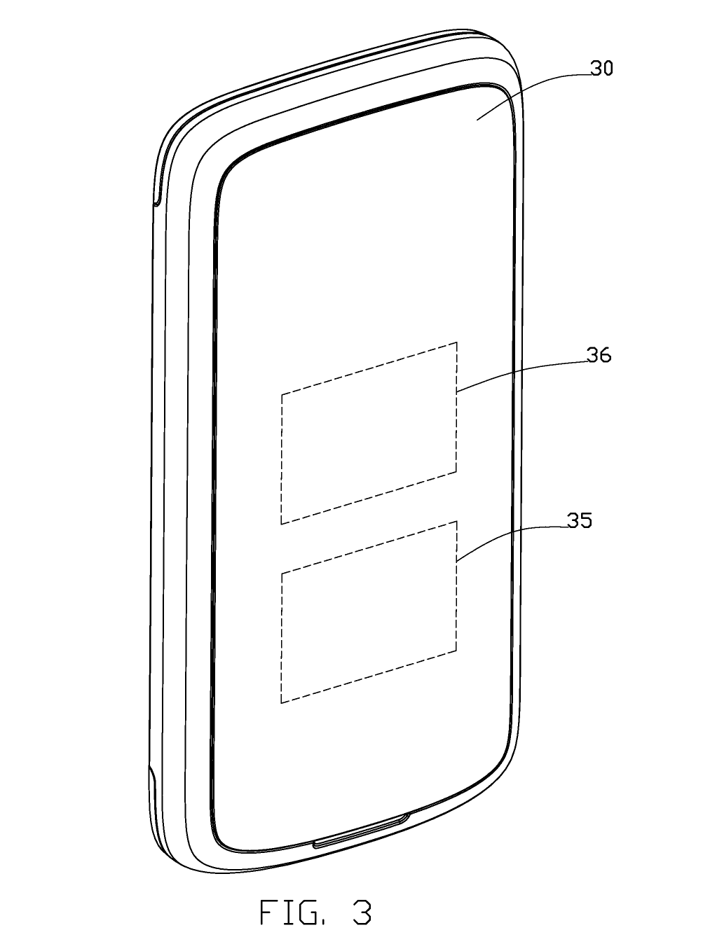

FIG. 3 illustrates the electronic device 30 in a schematic view. The second data transmitting chip 35 can be located under the charger receiver 36.

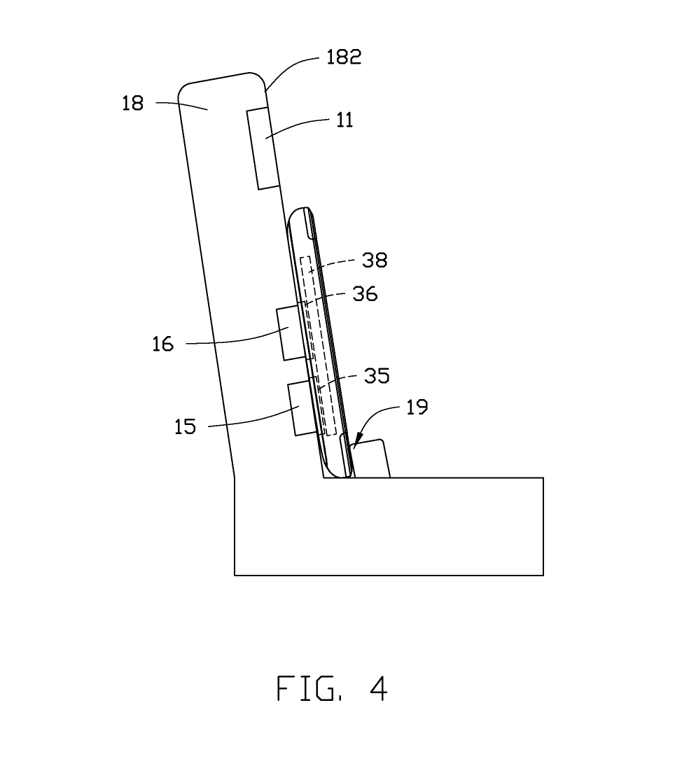

FIG. 4 illustrates a using state of the electronic device 30 in the dock 18. In use, the electronic device 30 is placed in the docking bay 19. The electronic device leans against the positioning board 182 of the dock 18. The second data transmitting chip 35 is aligned with the first data transmitting chip 15, and the charger receiver 36 is aligned with the charger base 16. The car multimedia device can communicate with the electronic device through the first data transmitting chip 15 and the second data transmitting chip 35. The controller can transmit display content from the electronic device to the display 11 of the car multimedia device. The electronic device can also be charged through the charger base 16.

In one embodiment, the display 11 can be a touch sensitive display. The car multimedia device can control the electronic device to play multimedia content when the electronic device is coupled.

The embodiments shown and described above are only examples. Many details are often found in the art such as the other features of a car multimedia device . Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A car multimedia device comprising:
a docking bay, configured to hold an electronic device;
a positioning board located on one side of the docking bay;
a display coupled to the positioning board; and
a data transmitting chip positioned near to the positioning board and electronically coupled to the display;
wherein when the electronic device is located in the docking bay, the electronic device is configured to lean against the positioning board for facilitating communicating with the data transmitting chip.

2. The car multimedia device of claim 1, wherein the data transmitting chip comprises a NFC chip.

3. The car multimedia device of claim 1, wherein the data transmitting chip comprises a WiFi chip.

4. The car multimedia device of claim 1, wherein the positioning board is slanted relative to a horizontal surface to receiving the electronic device.

5. The car multimedia device of claim 1, wherein the docking bay is substantially U-shaped.

6. The car multimedia device of claim 1, further comprising a charger base, wherein the charger base is near to the positioning board.

7. The car multimedia device of claim 6, wherein the charger base and the data transmitting chip are powered by an in-car power supply, and are aligned in a plane.

8. The car multimedia device of claim 6, wherein the charger base is wireless charger base.

9. The car multimedia device of claim 1, further comprising a controller, wherein the controller is configured to transmit displayed content form the electronic device to the display.

10. A car multimedia device comprising:
a positioning board; and
a data transmitting chip near to the positioning board and comprising a NFC chip;
wherein when an electronic device is configured to lean against the positioning board for facilitating coupling to the NFC chip.

11. The car multimedia device of claim 10, further comprising a display, wherein the data transmitting chip is coupled to the display.

12. The car multimedia device of claim 11, further comprising a controller, wherein the controller is configured to transmit displayed content form the electronic device to the display.

13. The car multimedia device of claim 10, wherein the data transmitting chip comprises a WiFi chip.

14. The car multimedia device of claim 10, wherein the positioning board is slanted relative to a horizontal surface to receiving the electronic device.

15. The car multimedia device of claim 10, wherein the docking bay is substantially U-shaped.

16. The car multimedia device of claim 10, further comprising a charger base, wherein the charger base is near to the positioning board.

17. The car multimedia device of claim 16, wherein the charger base and the data transmitting chip are powered by an in-car power supply, and are aligned in a plane.
